(19) United States
(12) Patent Application Publication
(10) Pub. No.: US 2016/0114614 A1
(43) Pub. Date: Apr. 28, 2016

(54) Scrapbook Cards

(71) Applicant: Colleen Daniels, Wilkes Barre, PA (US)

(72) Inventor: Colleen Daniels, Wilkes Barre, PA (US)

(21) Appl. No.: 14/981,798

(22) Filed: Dec. 28, 2015

Related U.S. Application Data
(63) Continuation-in-part of application No. 14/476,096, filed on Sep. 3, 2014, now abandoned.
(60) Provisional application No. 61/873,453, filed on Sep. 4, 2013.

(51) Int. Cl. B42D 15/04

(52) U.S. Cl. CPC B42D 15/045

(57) ABSTRACT

The invention is directed to greeting cards that are reused to commemorate special occasions through designing scrapbooks, decorating picture frames, shadow box frames and/or photo albums. Removable embellishments from the greeting cards would be used to design and decorate any of the above. The greeting cards are printed in full color and may be customized with print, handwriting, photographs, a memorable document and other common scrapbooking articles. The cards are specially created with removable embellishments and boarders, using paper processes such as perforations, diecutting, temporary glue to make many of the special features of the card easily removable for reuse on other projects. A set of prepared decorations may be mixed and matched to create infinate variety of ideas which may be placed in scrapbooks, on photo frames or photo albums. This will uniquely provide a second time use for greeting cards which are currently a single use item.

### CROSS-REFERENCE TO RELATED APPLICATIONS

This application is a continuation in part of co-pending U.S. patent application Ser. No. 14/476,096, filed on Sep. 3, 2014, which claimed priority to U.S. Provisional Application No. 61/873,453, filed Sep. 4, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to hobby and craft supplies and accessories and in particular to decorative greeting cards for commemorating special occasions. The decorative greeting cards can be used to decorate in scrapbooks, photo frames, photo albums, shadowboxes, or any other similar item. The hobby of arts and crafts has become very popular, as users create elaborate scrapbooks which combine photos, written messages, bits of wrapping paper and ribbons, and assorted other items to create unique written histories of their families. Users also personalize photo frames and photo albums by attaching personal items to the front surface. In an age that has become increasingly electronic and impersonal, personalized items become a delightful anachronism for many users. These people often choose decorative accents for their personalized items that provide reminders of weddings, graduations, class reunions, holiday gatherings, and other very special days in their families' lives. Greeting cards are often purchased for such occasions, but these are often discarded. A series of decorative adhesive greeting cards to commemorate these special occasions, which include removable embellishments to be used in decorating these personal items after being used as greeting cards, would appeal to many users.

### SUMMARY OF THE INVENTION

Accordingly, the invention is directed to decorative greeting cards for commemorating special occasions in scrapbooks. Greeting cards with removable components to commemorate special occasions would appeal to many users. The greeting cards are printed in full color and may feature components with a peel-and-stick removable adhesive backing. The components may be customized with print writing, handwriting, photographs, a memorable document, and other common scrapbooking articles. The cards are specially created and designed with removable embellishments, using such processes as perforations and die cutting. The various embellishments may provide a three dimensional texture or raised elements, or may comprise flat printed words and images. A set of prepared decorations, such as paper frames, removable tiles, numbers, clip art, and the like may be mixed and matched to create an infinite variety of scrapbook items that may be placed within a scrapbook.

This will provide a second use for greeting cards and similar materials which are currently single-use items, and will appeal to many buyers. It will serve to stimulate interest in the hobby of scrapbooking, thereby increasing sales of other materials necessary for the hobby.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate two embodiments of the invention and, together with the description, serve to explain the principles of the invention.

FIG. 1 shows an inside front view of the greeting card of the first exemplary embodiment opened up, displaying the printed message 10, the decorative border 11, the greeting card 12, the small clip art items 13, and the perforated edges 20.

FIG. 2 shows an outside front view of the greeting card of the first exemplary embodiment closed, displaying the printed message 10, the greeting card 12, the large clip art item 14, and the perforated edges 20.

FIG. 3 shows a front view of the first exemplary embodiment where the embellishments have been removed from the greeting card and attached to a scrapbook page, displaying the printed message 10, the decorative border 11, the small clip art items 13, the large clip art item 14, and the scrapbook page 21.

FIG. 4 shows a front view of the first exemplary embodiment where the embellishments have been removed from the greeting card and attached to a scrapbook page, displaying the printed message 10, the decorative border 11, the small clip art items 13, the scrapbook page 21, and a personal photo 22.

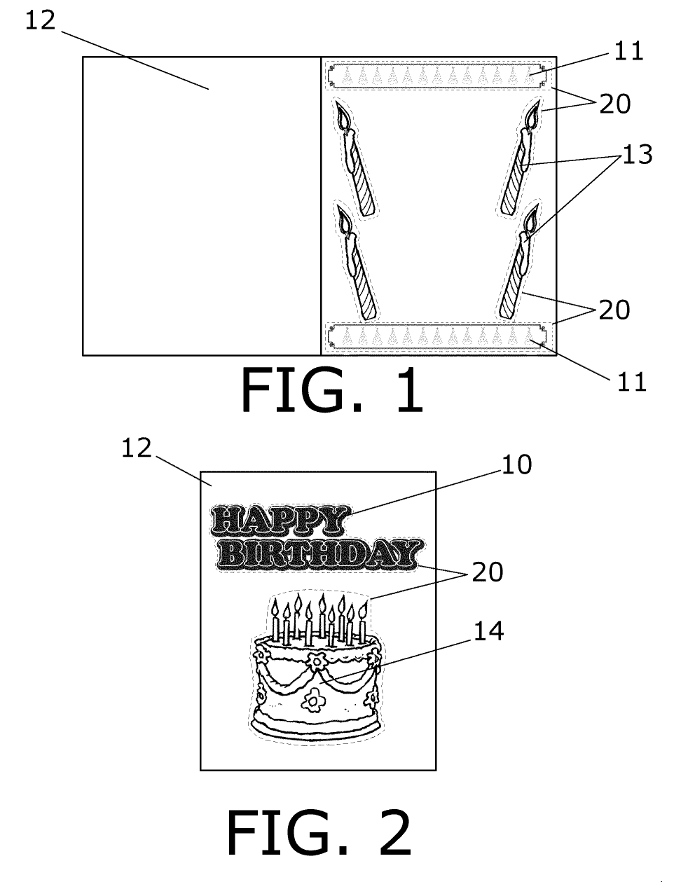

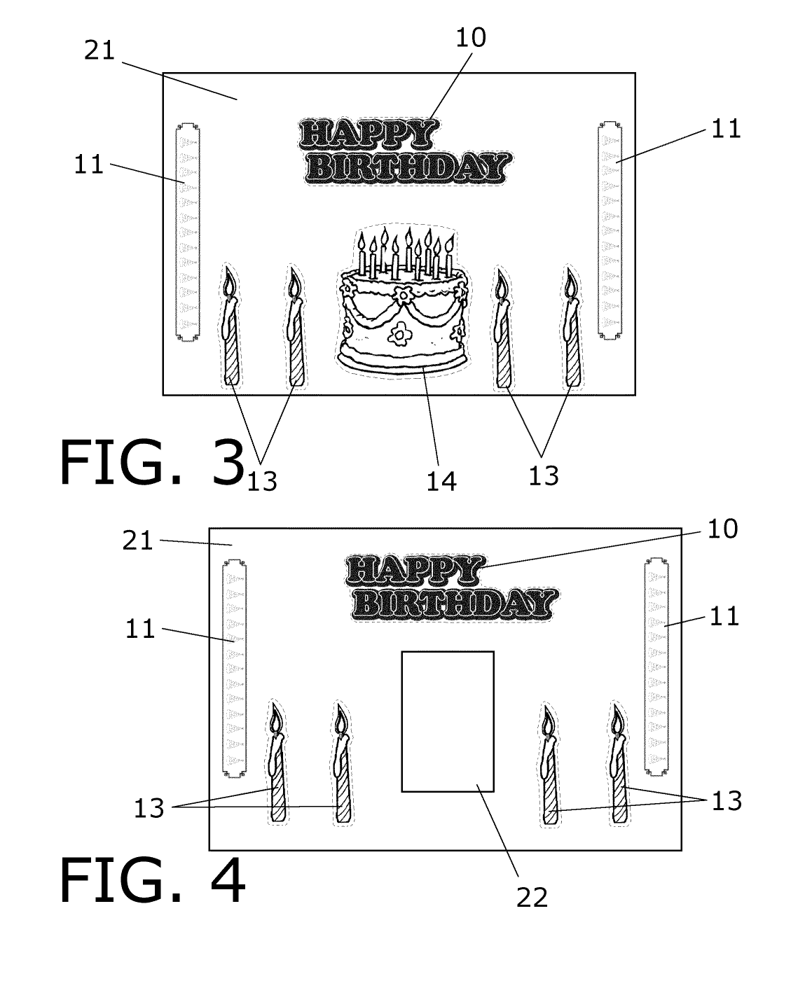

### DETAILED DESCRIPTION OF THE INVENTION

Referring now to the invention in more detail, the invention is directed to a decorative greeting cards with removable embellishments (10, 11, 13, and 14) for commemorating special occasions in scrapbooks. A series of decorative removable embellishments (10, 11, 13, and 14) included on a greeting card 12 to commemorate special occasions would appeal to many users. The greeting cards are printed in full color and may feature embellishments (10, 11, 13, and 14) which are attached to the greeting card via a mild adhesive. These embellishments may be customized with print writing, handwriting, photographs, a memorable document, and other common scrapbooking articles. Alternatively the cards are specially created and designed with removable embellishments (10, 11, 13, and 14), using such processes as perforations and die cutting 20. A set of removable embellishments (10, 11, 13, and 14) from the greeting card, such as paper frames, removable titles, numbers, clip art, and the like may be mixed and matched to create an infinite variety of scrapbook items that may be placed on a scrapbook page 21, or on phot frames, photo albums, shadowboxes, or any other similar item.

The first exemplary embodiment is printed as a birthday card, featuring as its removable embellishments a printed message 10, a decorative border 11, four small clip art items 13, and one large clip art item 14. A broad variety of alternate embodiments, printed as birthday cards or as greeting cards for other occasions, and featuring a broad assortment of different components, is also contemplated. To use the first exemplary embodiment, the user who received the greeting card 12 removes the embellishments (10, 11, 13, and 14), from the greeting card 12 by separating the perforations or die cuts 20. The embellishments (10, 11, 13, and 14) may then be affixed in the desired position on a scrapbook page 21. The item being decorated with the embellishments (10, 11, 13, and 14) may also include personal items not provided by the greeting card 12, such as personal photos, notes, or messages 22.

Alternatively, some or all of the removable embellishments (10, 11, 13, and 14) may be attached to the greeting card 12 using a mild adhesive such that they may be removed from the greeting card 12 without damaging the embellishments (10, 11, 13, and 14).

The printed messages 10, the decorative borders 11, the decorative backgrounds 12, the small clip art items 13, and the large clip art items 14 are preferably manufactured from a flexible, durable material such as paper or cardstock. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A greeting card with removable embellishments, comprising:
(a) a greeting card;
(b) said greeting card having at least one removable embellishment;
(c) said removable embellishment being customized with print writing, handwriting, photographs, memorable documents, clipart, images, numbers, letters, or other common scrapbooking articles;
(d) one or more of said removable embellishments are printed on said greeting card and are removable from said greeting card via perforations or die cutting;
(e) said removable embellishments being configured so that they may be removed from said greeting card and subsequently attached to a scrapbook page.

2. The greeting card with removable embellishments of claim 1, wherein said at least one removable embellishment is a plurality of removable embellishments.

3. The greeting card with removable embellishments of claim 2, wherein one or more of said removable embellishments are attached to said greeting card using a mild adhesive such that said removable embellishments may be removed from said greeting card without damaging said removable embellishment.

4. The greeting card with removable embellishments of claim 1, wherein said greeting card and said removable embellishments are themed to an occasion.

5. The greeting card with removable embellishments of claim 4, wherein said themed occasion is a birthday.

6. The greeting card with removable embellishments of claim 3, wherein said greeting card and said removable embellishments are themed to an occasion.

7. The greeting card with removable embellishments of claim 6, wherein said themed occasion is a birthday.

8. A greeting card with removable embellishments, comprising:
(a) a greeting card;
(b) said greeting card having at least one removable embellishment;
(c) said removable embellishment being customized with print writing, handwriting, photographs, memorable documents, clipart, images, numbers, letters, or other common scrapbooking articles;
(d) one or more of said removable embellishments are attached to said greeting card using a mild adhesive such that said removable embellishments may be removed from said greeting card without damaging said removable embellishment;
(e) said removable embellishments being configured so that they may be removed from said greeting card and subsequently attached to a scrapbook page.

9. The greeting card with removable embellishments of claim 8, wherein said at least one removable embellishment is a plurality of removable embellishments.

10. The greeting card with removable embellishments of claim 9, wherein one or more of said removable embellishments are printed on said greeting card and are removable from said greeting card via perforations or die cutting.

11. The greeting card with removable embellishments of claim 8, wherein said greeting card and said removable embellishments are themed to an occasion.

12. The greeting card with removable embellishments of claim 11, wherein said themed occasion is a birthday.

13. The greeting card with removable embellishments of claim 10, wherein said greeting card and said removable embellishments are themed to an occasion.

14. The greeting card with removable embellishments of claim 13, wherein said themed occasion is a birthday.
